(19) United States
(12) Patent Application Publication
(10) Pub. No.: US 2003/0098431 A1
(43) Pub. Date: May 29, 2003

(54) Aerial valve for controlling gas flux

(76) Inventor: Lambert Wu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/991,776

(22) Filed: Nov. 26, 2001

(51) Int. Cl. F16K 1/00

(52) U.S. Cl. 251/207

(57) ABSTRACT

An aerial valve for controlling gas flux comprises a vessel connected between an air exit and an air entrance of a gas source and having an axial larger cavity; an inner container arranged and fixed in the axial larger cavity and having an axial middle cavity and two ventages corresponding to the air exit and the air entrance; an adjusting means having a hollow portion arranged in the axial middle cavity and having an air inlet, a smaller air outlet and a larger air outlet corresponding to the ventages, the two air outlets being communicated with the air inlet. The inner container is placed between the vessel and the adjusting means and is made of leakageproof material. The adjusting means is coaxially and rotably assembled with the vessel on bottom thereof.

### FIELD OF THE INVENTION

The present invention relates to an aerial valve for controlling gas flux, especially to an aerial valve for controlling the gas flux of gas source for vapor cleaner.

### BACKGROUND OF THE INVENTION

The prior art gas source 5, as shown in FIG. 1, generally comprises a flexible hose 6, a holding pipe 7, an extension tube 8 and a brush 9.

As shown in FIG. 1, the vapor generated by an internal heat (not shown) sprays from the brush 9 through the flexible hose 6, the holding pipe 7, and the extension tube 8 and is used for sterilization and cleaning.

Moreover, the gas source 5 generally comprises a flux controller in the holding pipe 7 and composed of a ventage 72 and a probe 71. As shown in FIG. 1A, the amount of gas flux is controlled by the relative position of the probe 71 with respect to the ventage 72. However, the amount of gas flux is not stable and the shut off of the gas flux is troublesome, wherein the probe 71 should be rotated by many turns.

### SUMMARY OF THE INVENTION

It is an object of the present invention to provide an aerial valve for controlling gas flux such that a stable gas flux can be provided and the amount of the gas can be conveniently controlled.

It is another object of the present invention to provide an aerial valve applied to an apparatus with gas source and requiring stable and controllable gas flux, such as a gas cleaner.

To achieve above object, the present invention provides an aerial valve for controlling gas flux comprising a vessel connected between an air exit and an air entrance of a gas source and having an axial larger cavity; an inner container arranged and fixed in the axial larger cavity and having an axial middle cavity and two ventages corresponding to the air exit and the air entrance; an adjusting means having a hollow portion arranged in the axial middle cavity and having an air inlet, a smaller air outlet and a larger air outlet corresponding to the ventages, the two air outlets being communicated with the air inlet. The inner container is placed between the vessel and the adjusting means and is made of leakageproof material. The adjusting means is coaxially and rotably assembled with the vessel on bottom thereof.

The various objects and advantages of the present invention will be more readily understood from the following detailed description when read in conjunction with the appended drawing, in which:

### BRIEF DESCRIPTION OF DRAWINGS

FIG. 1 shows a perspective view of prior art vapor cleaner;

FIG. 1A shows the aerial valve for the prior art vapor cleaner in FIG. 1;

FIG. 2 shows an exploded view of the present invention;

FIG. 3 shows a top view of the present invention;

FIG. 4 shows a sectional view along line 4-4 in FIG. 3;

FIG. 5 is an enlarged view in FIG. 4;

FIG. 6 shows that the aerial valve of the present invention is in a sealing state;

FIG. 7 shows that the aerial valve of the present invention is in a small flux mode; and

FIG. 8 shows that the aerial valve of the present invention is in a large flux mode.

### DETAILED DESCRIPTION OF THE INVENTION

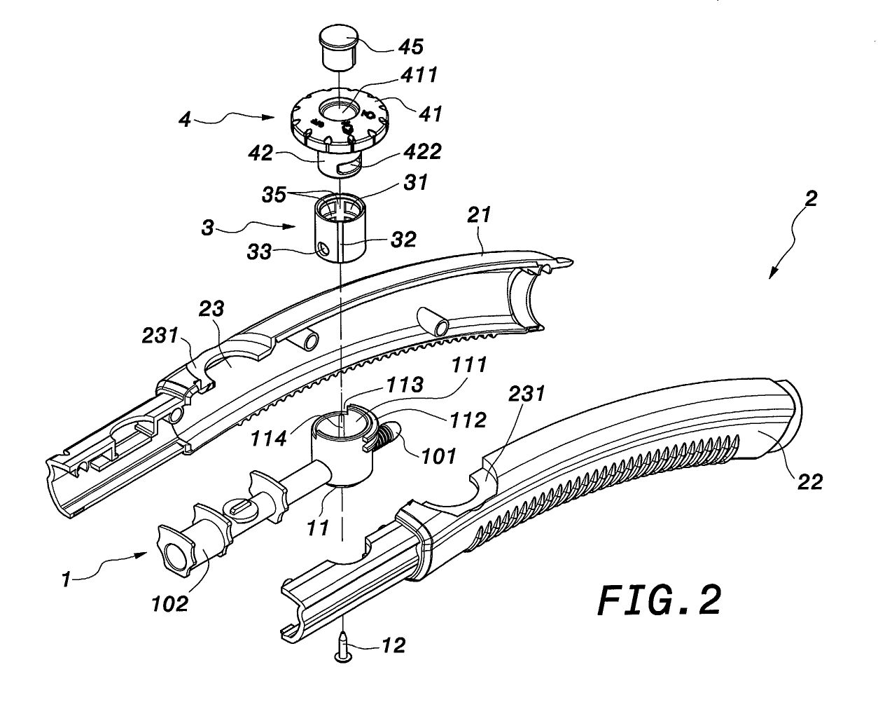

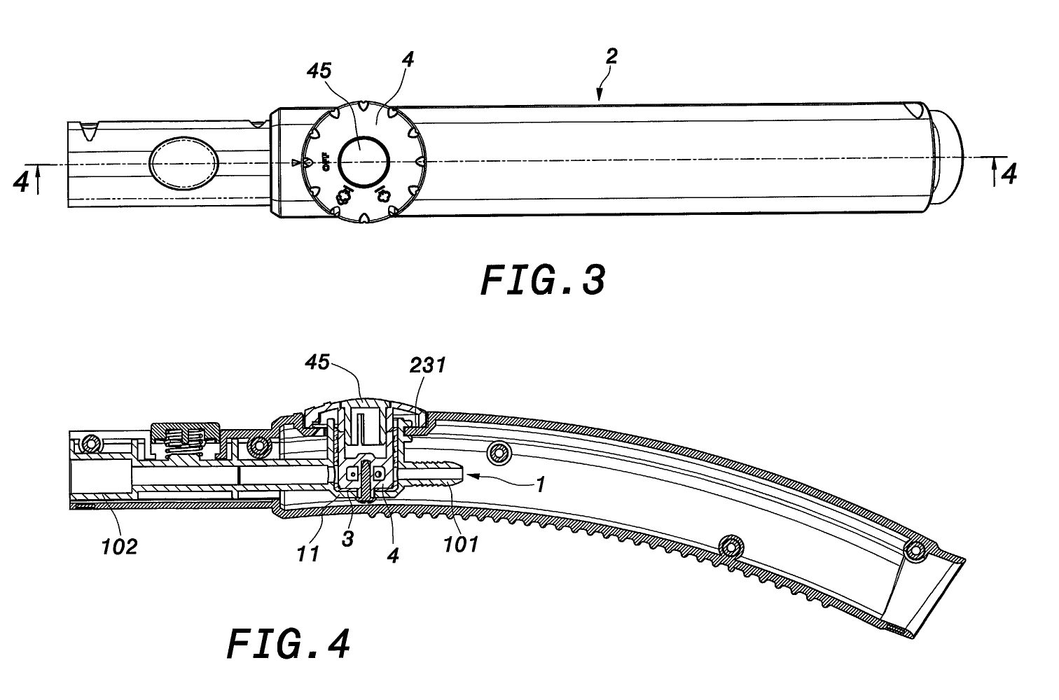

FIGS. 2 and 3 show an exploded view and a top view of the present invention, respectively. The present invention is intended to provide an aerial valve for controlling gas flux. The aerial valve comprises a controlling tube 1 with a container 11, an inner container 3 and an adjusting means 4. When the aerial valve is applied for a vapor cleaner, the holding pipe 2 receiving the aerial valve comprises two half-shells 21 and 22. The preferred embodiment of the present invention is exemplified by the vapor cleaner and described below.

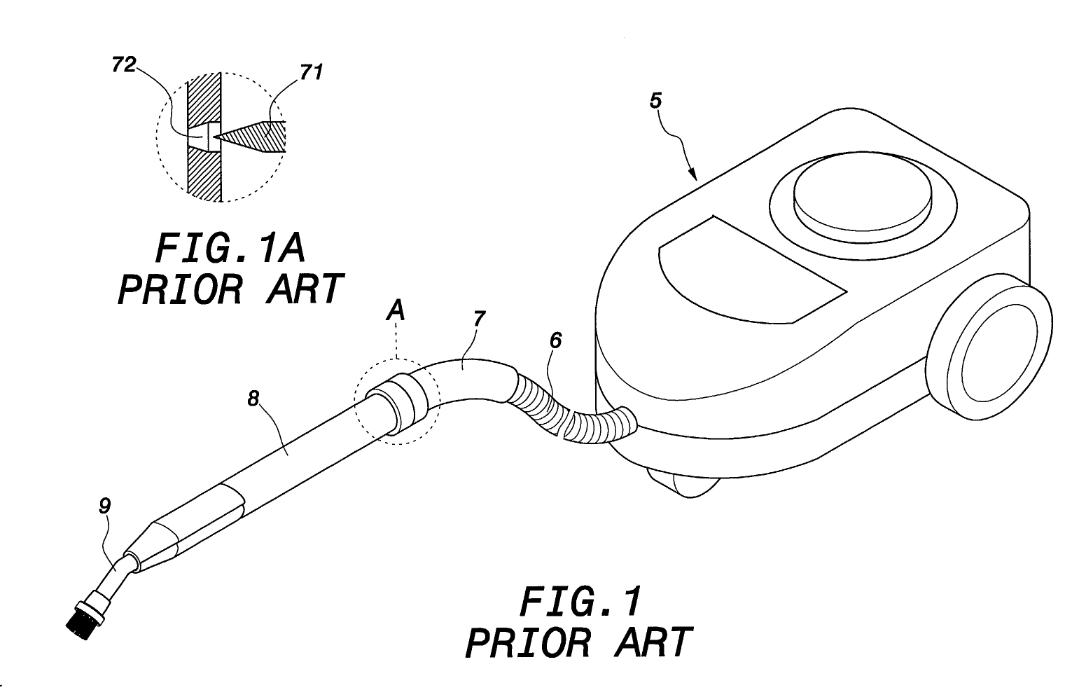

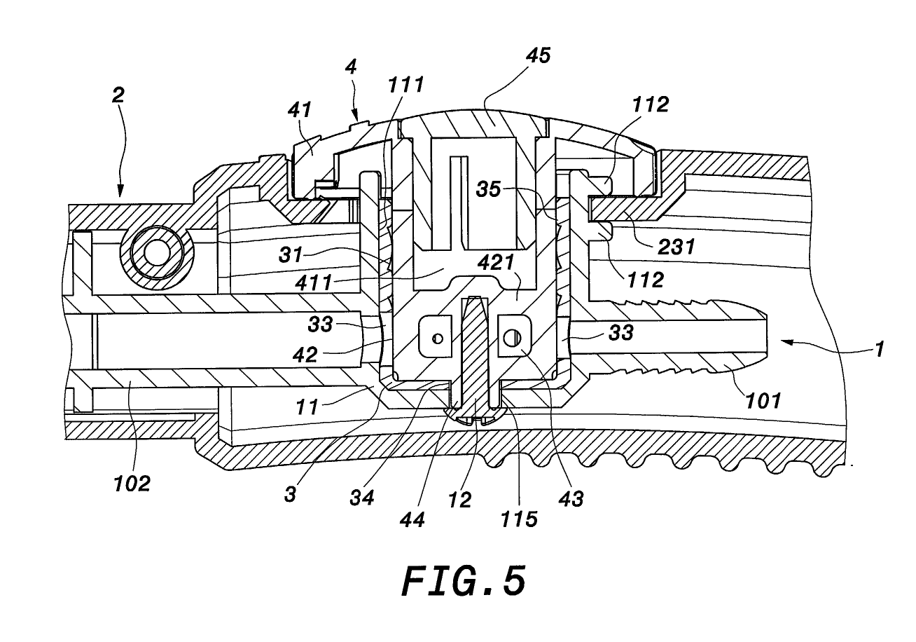

As shown in FIGS. 2 and 3, the controlling tube 1 comprises an intake tube 101, a spray tube 102 and a vessel 11 bridging the intake tube 101 and the spray tube 102. The intake tube 101 is communicated to the gas source through a flexible hose (such as the numeral 6 in FIG. 1). The spray tube 102 is communicated to a brush (such as the numeral 9 in FIG. 1) through an extension tube (such as the numeral 8 in FIG. 1). The vessel 11 has an axial larger cavity 111 with an opened end, while a dent 113 is formed on one portion of the opened end and two ribs 112 are formed on another portion of the opened end. The larger cavity 111 has a plurality of longitudinal strips 114 on inner wall thereof. With reference to FIGS. 4 and 5, the vessel 11 has a through hole 115 on bottom side thereof.

The two half-shells 21 and 22 are assembled to form a case enclosing the controlling tube 1 and having an opening 23. The opening 23 has an annulus flange 231 with stair-shaped profile on inner side thereof to receive a cap 41, which will be described later.

The inner container 3 has an axial middle cavity 31. The inner container 3 further has a plurality of slits 32 on outer wall thereof and corresponding to the longitudinal strips 114 and interlaced sealing ribs 35 on inner wall thereof. The inner container 3 further has two through ventages 33 corresponding to the intake tube 101 and the spray tube 102. With reference to FIGS. 4 and 5, the inner container 3 has a through hole 34 on bottom thereof and corresponding to the through hole 115.

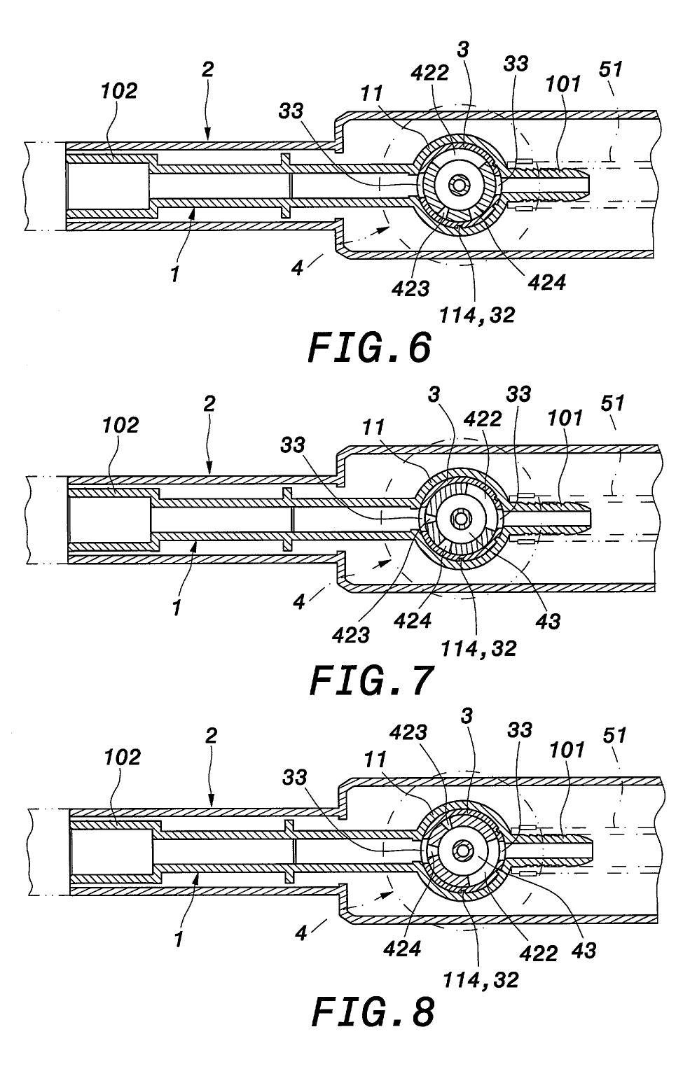

The adjusting means 4 comprises a cap 41 with larger diameter and a neck 42 with smaller diameter. The cap 41 is corresponding to the annulus flange 231 and exposes out of the annulus flange 231. The neck 42 can be inserted into the opening 23 and connected to other components. With reference to FIGS. 4 and 5, the neck 42 is integral with the cap 41 and a baffle plate 421 is formed in an hollow portion of the neck 42 such that a small cavity 411 is formed above the baffle plate 421 and an air chamber 43 is formed below the baffle plate 421. An axial shaft 44 extends from the baffle plate 421 and downward through the neck 42 and the through holes 34 and 115. The axial shaft 44 has hollow bottom end such that a retainer 12 is assembled to the axial shaft 44. The adjusting means 4 shown in FIGS. 4 and 5 is in closed state such that no ventage is shown. With reference now to FIGS. 6 to 8, the adjusting means 4 has an air inlet 422 and two air outlets (a smaller air outlet 423 and a larger air outlet 424) on altitude corresponding to the neck 42. The circumference length of the air inlet 422 is larger than the total circumference length of the smaller air outlet 423 and the larger air outlet 424. Therefore, the gas flow into the air inlet 422 can be flowed out from the smaller air outlet 423 or the larger air outlet 424.

The above-mentioned controlling tube 1, inner container 3 and adjusting means 4 together constitute the aerial valve for controlling gas flux according to the present invention.

The plug 45, as shown in FIG. 5, has ringer-shaped cross section and has a convex topside such that the plug 45 can be fit with an opening (not labeled) of the small cavity 411.

With reference to FIGS. 3 and 4, and especially to FIG. 5, the inner container 3 is placed in the axial larger cavity 111 and the neck 42 of the adjusting means 4 is placed within the axial middle cavity 31 of the inner container 3. The air entrance and exit (the intake tube 101 and the spray tube 102) of the controlling tube 1 are corresponding to the two through ventages 33. The shaft 44 passes through the stacked through holes 34 and 115. The retainer 12 is screwed or riveted to the bottom of the shaft 44. The adjusting means 4 can be rotated with the shaft 44 as a center. The retainer 12 has a head with larger diameter than that of the through hole 115 and the cap 41 abuts the flange 231 to assemble the adjusting means 4. The plurality of slits 32 on outer wall of the inner container 3 is engaged with the longitudinal strips 114 of the container 11 to inhibit the rotation of the inner container 3. In the present invention, there are three slits 32 and three longitudinal strips 114 and the three slits 32 and three longitudinal strips 114 are located on half circumference of the container 11 and the inner container 3, respectively, thus providing alignment polarization for the inner container 3. The inner container 3 placed between the neck 42 and the container 11 can be made of leakproof material such as flexible rubber. Moreover, the interlaced sealing ribs 35 on inner wall of the inner container 3 further provide airtight property between the adjusting means 4 and the container 11. The intake gas will flow into the air chamber 43 with stable flux intensity. The controlling tube 1 assembled with the inner container 3 and adjusting means 4 is placed in the holding pipe 2 formed by the two half-shells 21 and 22. The flange 231 is clamped between the ribs 112. The intake tube 101 is connected to the gas source through an input tube 51 as shown in FIG. 6. As shown in FIG. 1, the left end of the holding pipe 2 is connected to the brush 9 through an extension tube 8.

As shown in FIG. 6, the cap 41 has a symbol for marking larger gas flux at a position corresponding to the larger air outlet 424, a symbol for marking smaller gas flux at a position corresponding to the smaller air outlet 423, and OFF symbol for marking a sealing wall (no label) of the neck 42 being at position where the larger air outlet 424, the smaller air outlet 423 and the air inlet 422 are not located.

FIG. 6 shows that the aerial valve of the present invention is in a sealing state. The cap 41 extruding out of the holding pipe 2 can be rotated to rotate the neck 42 cling to the inner wall of the inner container 3. When the cap 41 is rotated to a position corresponding to OFF mark, the sealing wall of the neck 42 is aligned to the two through ventages 33 of the inner container 3. The aerial valve of the present invention blocks the gas flux injected from the input tube 51 to the intake tube 101. Therefore, the gas flux cannot transmit to the air chamber 43.

FIG. 7 shows that the aerial valve of the present invention is in a small flux mode. When the cap 41 is rotated to a position corresponding to small flux mark, the smaller air outlet 423 of the neck 42 is aligned with the left ventage 33 of the inner container 3 and the spray tube 102 of the controlling tube 1, the air inlet 422 of the neck 42 is aligned with the right ventage 33 of the inner container 3 and the intake tube 101 of the controlling tube 1. Therefore, the gas flowed into intake tube 101 can flow, through the right ventage 33 of the inner container 3, the air inlet 422 of the neck 42, the air chamber 43, the smaller air outlet 423 of the neck 42, the left ventage 33 of the inner container 3, to the spray tube 102. In this situation, the spray tube 102 sprays gas with small flux intensity.

FIG. 8 shows that the aerial valve of the present invention is in a large flux mode. When the cap 41 is rotated to a position corresponding to large flux mark, the larger air outlet 424 of the neck 42 is aligned with the left ventage 33 of the inner container 3 and the spray tube 102 of the controlling tube 1, the air inlet 422 of the neck 42 is aligned with the right ventage 33 of the inner container 3 and the intake tube 101 of the controlling tube 1. Therefore, the gas flowed into intake tube 101 can flow, through the right ventage 33 of the inner container 3, the air inlet 422 of the neck 42, the air chamber 43, the larger air outlet 424 of the neck 42, the left ventage 33 of the inner container 3, to the spray tube 102. In this situation, the spray tube 102 sprays gas with large flux intensity.

To sum up, the aerial valve of the present invention has excellent airtight property and provides stable and controllable flux intensity by its scrupulous design. Therefore, the vapor cleaner using the aerial valve of the present invention can spray high-temperature and stable vapor for cleaning.

Moreover, the aerial valve of the present invention can be applied to other applications requiring gas source 5 as shown in FIG. 1 and stable gas flux.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. An aerial valve for controlling gas flux, comprising:
a vessel connected between an air exit and an air entrance of a gas source and having an axial larger cavity;
an inner container arranged and fixed in the axial larger cavity and having an axial middle cavity and two ventages corresponding to the air exit and the air entrance;
an adjusting means having a hollow portion arranged in the axial middle cavity and having an air inlet, a smaller air outlet and a larger air outlet corresponding to the ventages, the two air outlets being communicated with the air inlet;
the inner container placed between the vessel and the adjusting means and being made of leakageproof material, the adjusting means is coaxially and rotably assembled with the vessel on bottom thereof.

2. The aerial valve for controlling gas flux as in claim 1, wherein the circumference length of the air inlet is larger than the total circumference length of the smaller air outlet and the larger air outlet.

3. The aerial valve for controlling gas flux as in claim 1, wherein the inner container is made of flexible rubber.

4. The aerial valve for controlling gas flux as in claim 1, wherein the inner container has interlaced sealing ribs on inner wall thereof.

5. The aerial valve for controlling gas flux as in claim 1, wherein the inner container has a plurality of slits on outer wall thereof, and the vessel has a plurality of longitudinal strips on inner wall thereof and engaged with the slits.

6. The aerial valve for controlling gas flux as in claim 5, wherein the inner container has three slits on half circumference thereof and the vessel has three longitudinal strips on half circumference thereof.

7. The aerial valve for controlling gas flux as in claim 1, wherein the adjusting means, the inner container and the vessel have an axial shaft, a through hole and a through hole, respectively on bottom thereof with the axial shaft passing through the through holes, a retainer screwed to the axial shaft from bottom of the vessel and having a head end having a larger diameter than the diameter of the through hole.

8. The aerial valve for controlling gas flux as in claim 1, wherein the adjusting means comprises a cap with larger diameter and a neck with smaller diameter, the cap exposing out of the vessel for operation and the neck received in the axial middle cavity, the neck comprising the air inlet, two air outlets and the axial shaft.

9. The aerial valve for controlling gas flux as in claim 1, wherein the vessel is placed between a controlling tube and the spray tube.

10. The aerial valve for controlling gas flux as in claim 1, wherein the aerial valve is applied to an apparatus with gas source and requiring stable and controllable gas flux, such as a gas cleaner.
